(19) United States
(12) Patent Application Publication
(10) Pub. No.: US 2013/0328391 A1
(43) Pub. Date: Dec. 12, 2013

(54) DEVICE FOR OPERATING A MOTOR VEHICLE

(71) Applicant: GM GLOBAL TECHNOLOGY OPERATIONS LLC, Detroit, DE (US)

(72) Inventor: Christian Rudolf JERUSALEM, Ruesselsheim (DE)

(73) Assignee: GM GLOBAL TECHNOLOGY OPERATIONS LLC, Detroit, MI (US)

(21) Appl. No.: 13/828,915

(22) Filed: Mar. 14, 2013

(30) Foreign Application Priority Data
Jun. 6, 2012 (DE) 102012011179.7

(51) Int. Cl. B60R 16/02

(52) U.S. Cl. CPC B60R 16/02
USPC 307/10.1

(57) ABSTRACT

A device for operating functions of a motor vehicle, with an operation control, which is designed for outputting control commands to further motor vehicle devices is provided. The control commands can be generated as a function of two or a plurality of simultaneous operation inputs, and a first touch-sensitive operating surface connected to the operation control in a signal-conducting manner, by means of which operating inputs can be transmitted to the operation control. At least one second touch-sensitive operating surface connected to the operation control in a signal-conducting manner is also provided.

### CROSS-REFERENCE TO RELATED APPLICATION

This application claims priority to German Patent Application No. 10 2012 011 179.7, filed Jun. 6, 2012, which is incorporated herein by reference in its entirety.

### TECHNICAL FIELD

The technical field relates to a device for operating functions of a motor vehicle. The device comprises an operating control which is designed for outputting commands to further motor vehicle devices. The control commands can be generated as a function of two or a plurality of simultaneous operating inputs.

### BACKGROUND

Devices of the type mentioned at the outset are known in the prior art. To operate functions of a vehicle, in particular of a motor vehicle, a series of different operating elements are usual, in particular levers, switches, buttons and the like. To operate multimedia functions, for example radios, music playback devices or further motor vehicle functions such navigation systems, air-conditioning settings, other motor vehicle settings and more of this type, turn and press controllers, joysticks and touch-sensitive screens are known.

From DE 10 2008 017 716 A1, a display and operating device as well as a method for operating such a display and operating device are known, wherein the display and operating device comprises a display device, a touch-sensitive position sensing unit coupled to the display device and a control device coupled to the display device and the position sensing unit, which comprises an evaluation logic, which evaluates touch positions sensed by the position sensing unit and by way of this influences a control of a representation of information on the display device and a calling-up of functions and/or controlling of systems that can be operated via the display and operating device, wherein the evaluation logic is designed to evaluate the sensed touch positions in a time-resolved manner.

In DE 10 2009 057 739 A1, an operating device for a vehicle having an operating element is additionally disclosed, which comprises an operating surface and a sensing device, with which a location of a finger of a user of the operating surface can be sensed, with which a pressure which the finger presses on the operating surface can also be sensed with the sensing device, and the sensed location and the sensed pressure can be provided by the sensing device and an image corresponding to the sensed location and the sensed pressure can be displayed on a display unit which is separate from the operating element and the sensing device.

However, the operation of such devices always requires a free hand.

In addition, other objects, desirable features and characteristics will become apparent from the subsequent summary and detailed description, and the appended claims, taken in conjunction with the accompanying drawings and this background.

### SUMMARY

Accordingly, the present disclosure provides a device for operating functions of a motor vehicle, which can also be operated with supported hands.

A device according to the present disclosure for operating functions of a motor vehicle comprises an operating control, which is designed for outputting commands to further devices of the motor vehicle, for example to a multimedia system, a navigation system or an automatic air-conditioning system.

The control commands can be generated as a function of two or more simultaneous operating inputs. Such control inputs are also called gesture operations or in English multi-touch inputs. It is known for example by placing two fingers and forming different gestures using more than two fingers to trigger different operating end commands. Spreading the fingers can for example zoom in a representation. A circular movement of both fingers simultaneously can for example rotate an image. Wiping with one, two, three or more fingers in certain directions simultaneously can trigger different operating commands in each case.

Furthermore, a first operating surface is provided, which is touch-sensitive and connected to the operating control in a signal-conducting manner, so that operating inputs generated by touching the touch-sensitive operating surface can be transmitted to the operation control.

According to the present disclosure, a second operating surface is provided, which is likewise connected to the operation control in a signal-conducting manner, wherein the second operating surface is also touch-sensitive and wherein by way of the second operating surface, operating inputs can also be transmitted to the operation control.

With the device according to the present disclosure it is thus possible to perform functions of the motor vehicle through simultaneous operation of two separate touch-sensitive operating surfaces. According to a further possible configuration of the present disclosure it can be provided that the second operating surface is arranged separately from the first operating surface. Thus, the two operating surfaces can be arranged ergonomically favorably in the vehicle interior of the motor vehicle, so that a comfortable and low-distraction operation of functions of the motor vehicle is possible.

According to an exemplary embodiment of the present disclosure it can be provided that the first operating surface and the second operating surface can have a defined orientation with respect to each other. In this way, the operation control can exactly interpret the operating inputs which are carried out distributed over the two operating surfaces and a larger number of possible operating inputs is possible.

According to another exemplary embodiment of the present disclosure it can be provided that the two operating surfaces are connected to the operation control connected in parallel or in series. In the case of a series connection, an existing vehicle bus system can be used.

According to one exemplary embodiment of the present disclosure it can be provided that the first operating surface and the at least one second operating surface are designed for sensing a position of the operating inputs on the respective operating surface. In this way it is possible by touching the operating surface in different locations to trigger different operating commands.

According to one exemplary embodiment of the present disclosure it can be provided that the first operating surface and the at least one second operating surface are designed for sensing a direction of the operating inputs on the respective operating surface. In this way, further operating commands can be made possible which do not only depend on a point-touch, but on a certain gesture, for example a stroking or a turning.

According to one exemplary embodiment of the present disclosure it can be provided that the first operating surface and the second operating surface are arranged next to each other, on top of each other, on the front and back of an object, coaxially with respect to an object or located diametrically opposite an object. The object can in particular be an instrument panel, a center console, an internal door pulling device, a door covering, a headlining or an operating lever such as a gear selector lever. Depending on the respective purpose, ergonomical operations can be made possible with this arrangement.

According to another exemplary embodiment of the present disclosure it can be provided that the first operating surface and the second operating surface are arranged on a steering wheel of the motor vehicle. This makes possible a gesture operation without the drive having to take his hands off the steering wheel while driving.

According to one exemplary embodiment of the present disclosure it can be provided that the first operating surface and the second operating surface are arranged on a steering wheel spoke each, wherein the relevant spokes are located on opposite sides of a steering wheel hub of the steering wheel. In normal position of the steering wheel, the first operating surface is then located on the right, the second operating surface on the left of the hub or vice versa. In this way, an operation with the thumb is made possible without having to take the hands off the steering wheel.

According to one exemplary embodiment of the present disclosure it can be provided that the first operating surface is arranged on the steering wheel front side facing a drive and the second operating surface on a steering wheel back side facing away from the driver. This allows the simultaneous operation by means of thumb and index finger.

According to one exemplary embodiment of the present disclosure it can be provided that the first operating surface and the second operating surface are arranged on the same steering wheel spoke on front and back sides. In this way, gestures can be realized which for example correspond to a turning of a wheel, which is arranged at a right angle to the steering wheel axis. Pushing gestures, towards the top or towards the bottom perpendicular to the steering wheel axis are also possible.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 is a motor vehicle with a device according to the present disclosure according to a first exemplary embodiment;

FIG. 2 is a motor vehicle with a device according to the present disclosure according to a second exemplary embodiment;

FIG. 3 is a steering wheel with parts of the device according to the present disclosure according to the second exemplary embodiment; and

FIG. 4 is a steering wheel with parts of a device according to the present disclosure according to a third exemplary embodiment.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

In the following figures, same or functionally same components are provided with the same reference numbers.

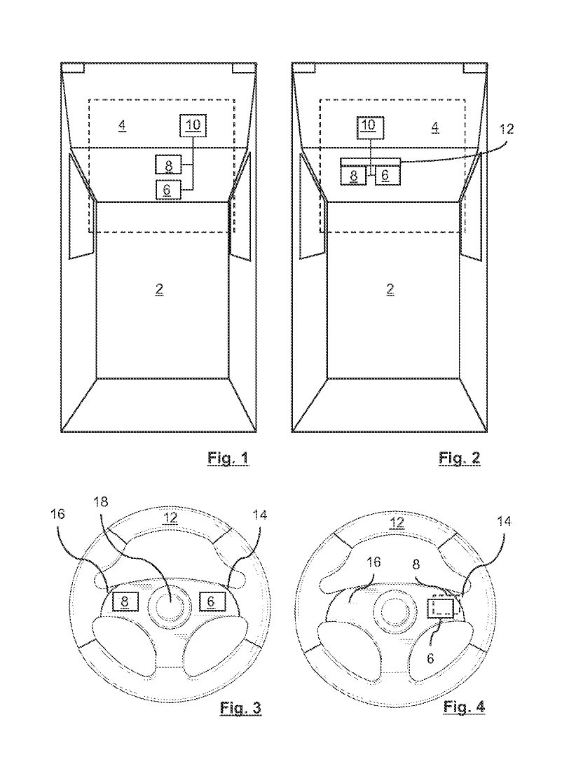

FIG. 1 shows a motor vehicle 2 with a device 4 according to the present disclosure. Parts of the device 4 are framed in interrupted lines.

The device 4 comprises a first operating surface 6 and a second operating surface 8. The two operating surfaces 6, 8 are arranged separately from each other in a center console.

The orientation of the two operating surfaces 6, 8 with respect to one another is defined and stored in the operation control 10, so that the operation control 10 can correctly interpret gestures which are carried out simultaneously on the first operating surface 6 and on the second operating surface 8.

The operating surfaces 6, 8 are designed two-dimensionally and in a touch-sensitive manner. Touches or gestures performed on the two-dimensionally spread surface of the relevant operating surface 6, 8 in different locations are correspondingly transmitted from the operating surfaces 6, 8 to the operation control 10 stating the location of the touch and the gesture as well as the direction of the gesture. To establish gestures that have been performed a regular query of the state of the respective operating surfaces can take place, so that gestures such as for example wiping can be rendered detectable through changes of the location of the respective touch from query to query.

FIG. 2 shows an alternative embodiment of a device 4 according to the present disclosure, in which the operating surfaces 6, 8 are arranged on a steering wheel 12. Details regarding the arrangement are reflected in FIG. 3.

FIG. 3 shows a front view of a steering wheel 12, on which a first operating surface 6 and a second operating surface 8 are arranged.

The first operating surface 6 is arranged on a first spoke 14, the second operating surface 8 on a second spoke 16. The two spokes 14, 16 and thus the two operating surfaces 6, 8 are located on different sides of a steering wheel hub 18.

The operation of the two operating surfaces 6, 8 is possible with the respective right and left thumbs. The remaining fingers of the two hands can remain on the steering wheel 12. Thus, the operating surfaces 6, 8 can also be actuated while cornering.

On the operating surfaces 6, 8 gestures can be performed which correspond to usual gestures. For example, simultaneous moving of the thumbs to the outside in a navigation mode can be interpreted as an enlargement request, moving the thumbs towards the inside as a reduction request.

FIG. 4 shows a steering wheel 12 in a second embodiment, in which the operating surfaces 6, 8 are arranged on the spoke 14.

The operating surface 6 is arranged on the side of the steering wheel 12 facing the driver, the operating surface 8 is arranged on the back facing away from the driver and therefore represented in interrupted lines. The operating surface 6 can be actuated with the thumb, the operating surface 8 with an index finger.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1. A device for operating functions of a motor vehicle, comprising:
an operation control designed for outputting control commands to further motor vehicle devices, the control commands generated as a function of two or a plurality of simultaneous operation inputs;
a first touch-sensitive operating surface connected to the operation control in a signal conducting manner, by means of which operating inputs can be transmitted to the operation control; and
at least one second touch-sensitive operating surface connected to the operation control in a signal-conducting manner.

2. The device according to claim 1, wherein the at least one second operating surface arranged separately from the first operating surface.

3. The device according to claim 1, wherein the first operating surface and the at least one second operating surface have a defined orientation with respect to one another.

4. The device according to claim 1, wherein the first operating surface and the at least one second operating surface are connected to the operation control in parallel or in series.

5. The device according to claim 1, wherein the first operating surface and the at least one second operating surface are designed for sensing a position of the operating inputs on the respective operating surface.

6. The device according to claim 1, wherein the first operating surface and the at least one second operating surface are designed for sensing a direction of the operating inputs on the respective operating surface.

7. The device according to claim 1, wherein the first operating surface and the at least one second operating surface are arranged next to each other, on top of each other, on the front and back of an object, coaxially to an object or located diametrically opposite an object.

8. The device according to claim 1, wherein the first operating surface and the at least one second operating surface are arranged on a steering wheel of the motor vehicle.

9. The device according to claim 8, wherein the first operating surface and the at least one second operating surface are each arranged on a steering wheel spoke, which are located on sides of a steering wheel hub of the steering wheel located opposite each other.

10. The device according to claim 8, wherein the first operating surface is arranged on a steering wheel front side facing a driver and the at least one second operating surface on a steering wheel back side facing away from the driver.

11. The device according to claim 10, wherein the first operating surface and the at least one second operating surface are arranged on the same steering wheel spoke.
